(19) United States
(12) Patent Application Publication
(10) Pub. No.: US 2026/0050966 A1
(43) Pub. Date: Feb. 19, 2026

(54) SIMULTANEOUS LIST AND CAMERA COMPUTER-READABLE INDICIA SCANNER SPLIT VIEW

(71) Applicant: Shopify Inc., Ottawa (CA)

(72) Inventors: Tobias Negele, Colwood (CA); Helen Mou, Stratham, NH (US); Eric Wichman, York (CA)

(21) Appl. No.: 18/804,886

(22) Filed: Aug. 14, 2024

(51) Int. Cl. G06Q 30/0601; G06K 7/14

(52) U.S. Cl. CPC G06Q 30/0633; G06K 7/1413

(57) ABSTRACT

Systems and methods are disclosed for presenting, on a display of a portable computing device having an integrated camera, a Graphical User Interface (GUI) that enables simultaneous scanning of computer-readable indicia affixed to items and a resulting list of scanned items.

### TECHNICAL FIELD

The present disclosure relates to the use of a portable computing device for scanning items and creating corresponding lists of items.

### BACKGROUND

Tablet computers are increasingly being used in commercial and industry environments. For example, tablet computers are used as Point Of Sale (POS) devices in retail environments, as inventory management tools in warehouse environments, as patient management tools in healthcare facilities, etc.

### SUMMARY

Systems and methods related to providing a simultaneous camera view and list view on a portable computing device having an integrated camera for scanning of items and updating a corresponding list of items are disclosed. In some embodiments, a computer-implemented method comprises simultaneously presenting, on a display of a portable computing device having an integrated camera, a Graphical User Interface (GUI) of a software application, wherein the GUI includes a camera view in a first area of the display of the portable computing device and a list view in a second area of the display of the portable computing device. The camera view presents a live view of a field-of-view of the integrated camera, and the list view presents a list of items. The method further comprises continuously scanning, by the portable computing device, for a computer-readable indicia viewable within the camera view and, as a result of continuously scanning for a computer readable indicia viewable within the camera view, detecting, by the portable computing device, a computer-readable indicia viewable within the camera view, the computer-readable indicia being associated to an item. The method further comprises updating the list of items presented within the list view to include human-readable indicia of the item associated to the detected computer-readable indicia. In this manner, efficient scanning of items is enabled in such a way that usage of computing resources of the portable computing device is reduced as compared to the conventional scanning solution which requires either a separate hardware scanning device or switching between different camera and list views.

In some embodiments, the first area is a function of a position of a lens of the integrated camera on a back-side of the portable computing device.

In some embodiments, the first area is a function of a position of a lens of the integrated camera on a back-side of the portable computing device such that the first area is at a position on the display of the portable computing device that is opposite the position of the lens of the integrated camera on the back-side of the portable computing device.

In some embodiments, the method further comprises, responsive to detecting the computer-readable indicia viewable within the camera view, querying a local database at the portable computing device or a remote database hosted by a server for any one or more items associated to the detected computer-readable indicia and receiving a response from the local or remote database, the response comprising information about the item associated to the detected computer-readable indicia.

In some embodiments, the detected computer-readable indicia is associated to two or more items, and the method further comprises, responsive to detecting the computer-readable indicia viewable within the camera view, simultaneously with presenting the camera view and the list view, presenting, within the GUI on the display of the portable computing device, information about the two or more items that are associated to the detected computer-readable indicia and receiving user input that selects one of the two or more items associated to the detected computer-readable indicia, wherein updating the list of items presented within the list view comprises updating the list of items presented within the list view to include human-readable indicia of the selected item associated to the detected computer-readable indicia. In some embodiments, presenting the information about the two or more items associated to the detected computer-readable indicia comprises presenting the information about the two or more items associated to the detected computer-readable indicia within the camera view.

In some embodiments, the detected computer-readable indicia is associated to two or more variations of the item, and the method further comprises, responsive to detecting the computer-readable indicia viewable within the camera view, simultaneously with presenting the camera view and the list view, presenting, within the GUI on the display of the portable computing device, information about the two or more variations of the item that are associated to the detected computer-readable indicia and receiving user input that selects one of the two or more variations of the item associated to the detected computer-readable indicia, wherein updating the list of items presented within the list view comprises updating the list of items presented within the list view to include human-readable indicia of the selected variation of the item associated to the detected computer-readable indicia. In some embodiments, presenting the information about the two or more variations of the item associated to the detected computer-readable indicia comprises presenting the information about the two or more variations of the item associated to the detected computer-readable indicia within the camera view.

In some embodiments, the method further comprises, responsive to detecting the computer-readable indicia viewable within the camera view, simultaneously with presenting the camera view and the list view, presenting, within the GUI on the display of the portable computing device, information about the item associated to the detected computer-readable indicia and receiving user input that confirms that the item is to be added to the list of items presented within the list view, wherein updating the list of items presented within the list view comprises updating the list of items presented within the list view to include human-readable indicia of the item associated to the detected computer-readable indicia responsive to receiving user input that confirms that the item is to be added to the list of items presented within the list view.

In some embodiments, the method further comprises, responsive to detecting the computer-readable indicia viewable within the camera view, simultaneously with presenting the camera view and the list view, presenting, within the GUI on the display of the portable computing device, information about the item associated to the detected computer-readable indicia and receiving user input that confirms that a certain number of the item is to be added to the list of items presented within the list view, wherein updating the list of items presented within the list view comprises updating the list of items presented within the list view to include human-readable indicia of the item associated to the detected computer-readable indicia and the certain number of the item, responsive to receiving user input that confirms that the certain number of the item is to be added to the list of items presented within the list view. In some embodiments, presenting the information about the item associated to the detected computer-readable indicia comprises presenting the information about the item associated to the detected computer-readable indicia within the camera view.

In some embodiments, the integrated camera is a rear-facing camera of the portable computing device, and the portable computing device is affixed to a stand.

Corresponding embodiments of a portable computing device are also disclosed.

### BRIEF DESCRIPTION OF THE DRAWINGS

Embodiments will be described, by way of example only, with reference to the accompanying figures wherein:

FIG. 1 illustrates one example of a portable computing device in which embodiments of the present disclosure may be implemented;

FIG. 2 is a flow chart that illustrates the operation of the software application at the portable computing device of FIG. 1, in accordance with embodiments of the present disclosure;

FIGS. 3A and 3B illustrate one example implementation of the portable computing device as a tablet computer;

FIGS. 4A and 4B show an illustrative example of the Graphical Unser Interface (GUI) provided by the software application in accordance with an example embodiment of the process of FIG. 2;

FIGS. 5A, 5B, 5C, and 5D illustrate examples in which the area of the display of the portable computing device in which the camera view for scanning items is presented is a function of the position of the lens of the integrated rear-facing camera of the portable computing device, in accordance with an embodiment of the present disclosure; and

FIG. 6 illustrates a “look-through” feature provided in accordance with an embodiment of the present disclosure.

Like reference numerals are used in the drawings to denote like elements and features.

### DETAILED DESCRIPTION OF EMBODIMENTS

The present disclosure relates to the use of a portable computing device (e.g., a tablet computer, smartphone, or the like) to scan items to create a list of items for any desired purpose (e.g., scan items using the portable computing device as a Point-of-Sale (POS) device to create a list of items being purchased (i.e., a shopping cart), scan items in a commercial or business environment to create a list of items in inventory, scan medical items and/or medications administered to a patient in a medical environment to create a corresponding list of medical items and/or medications, scan books being checked-out by a person at a library, etc.). Existing solutions for the use of a portable computing device for scanning items to create lists of items suffer from a number of problems.

In a first existing solution, a portable computing device is utilized as a POS device and is connected to a separate barcode reading device, which may be affixed to a portion of a counter or may alternatively be a handheld barcode reading device. However, the use of a separate barcode reading device suffers from the following problems. First, it requires separate hardware (i.e., the barcode scanning device), which is costly and can require a tailored configuration in order to work with the portable computing device, which operates as a display. Second, it introduces inefficiency. The end user must continually switch his/her attention between the barcode scanner to scan a new item and the portable computing device (or display) to ensure that the items are scanned correctly. In other words, the end user scans the barcode using the separate barcode reader, which requires that the user focuses on the barcode reader and away from the screen of the POS device. Once the barcode is scanned, the end user then refocuses his/her attention on the screen of the POS device to ensure that the correct item was scanned. This process is repeated for each new scanned item. This continued switching of the end user's attention between the barcode reader and the POS device causes the process to be inefficient.

In a second existing solution, a portable computing device is utilized as a POS device, and an integrated camera of the portable computing device is used to provide an integrated barcode reading device. While this integrated solution provides benefits over the use of a separate barcode reading device, the existing integrated solution requires that the end user switch between different views for scanning items and viewing the list of scanned items. This switching between different views results in the following problems. First, the switching between different views introduces inefficiency and latency into the scanning process. More specifically, when using the existing integrated solution, the end user first switches to a barcode scanner/camera view to scan the barcode of an item. Then, the end user typically switches to a list view to view the list of scanned items to confirm that the item scanned correctly. The end user then switches back to the barcode scanner/camera view to scan the barcode of the next item. The process continues in this manner until the end user has scanned all desired items. However, this repeated switching between the barcode scanner/camera view and the list view is inefficient and therefore introduces latency into the overall scanning process. Second, the switching between different views may require computing, and thus power, resources of the portable computing device. Minimizing the use of computing resources (and thus power consumption) is an important goal for portable computing devices. More specifically, each time the end user switches to the camera view to scan a new item, the integrated camera of the portable computing device may need to be re-initialized. In other words, the camera application on the portable computing device may reset each time the end user switches to the camera view. For example, if the end user previously zoomed into a particular digital zoom level or selected an optical zoom level, when the end user switches away from the camera view to, e.g., view the list of scanned items and then switches back to the camera view to scan a new item, such previously set camera settings are reset (i.e., lost) and the end user must again configure such settings. This requires associated computing, and thus power, resources. In addition, it introduces latency to the process, particularly if the end user has to manually reconfigure the camera settings.

Systems and methods are disclosed herein that address the aforementioned and/or other problems associated with the existing solutions for using a portable computing device to scan items to create lists of items for any purpose. Embodiments of the systems and methods disclosed herein provide a portable computing device with a split screen view that allows simultaneous visibility of a camera view and a list view. The camera view enables continuous scanning of computer-readable indicia (e.g., barcodes, Quick Response (QR) codes, or the like) affixed to or otherwise associated to items being scanned, while the list view provides simultaneous updating of a corresponding list of scanned items presented in the list view.

By providing the camera view, and thus the scanner functionality, in one area of the display of the portable computing device and simultaneously presenting the list of scanned items in the list view in another area of the display of the portable computing device, the end user does not need to frequently switch between different screens or windows or application views, which in turn provides the following improvements to the operation of the portable computing device. First, it reduces the amount of computing resources needed for operation, e.g., by avoiding the need to re-initiate or reconfigure the camera each time the end user switches back to the camera view to scan another item. Second, it provides reduced power consumption due to the reduced computing resources and/or due to reduced power consumption of the camera as a result of not needing to be re-initiated or reconfigured each time the end user switches back to the camera view to scan another item. Third, it provides an improved end user experience. In particular, by using embodiments of the present disclosure, the end user does not need to frequently switch between different views/screens (i.e., a first view for scanning and a second view for seeing the list of items), which in turn decreases the number of user inputs (e.g., touches, presses, etc.) in order to complete the process, thereby increasing efficiency. In addition, regarding the use of a separate barcode scanner that is connected to a POS device, by integrating the scanner function into the POS device using the built-in camera and by using the split screen view that shows both the camera view for scanning computer-readable indicia and the list view, the end user does not need to switch his/her attention back and forth between a barcode scanner and the POS screen, which in turn increases efficiency.

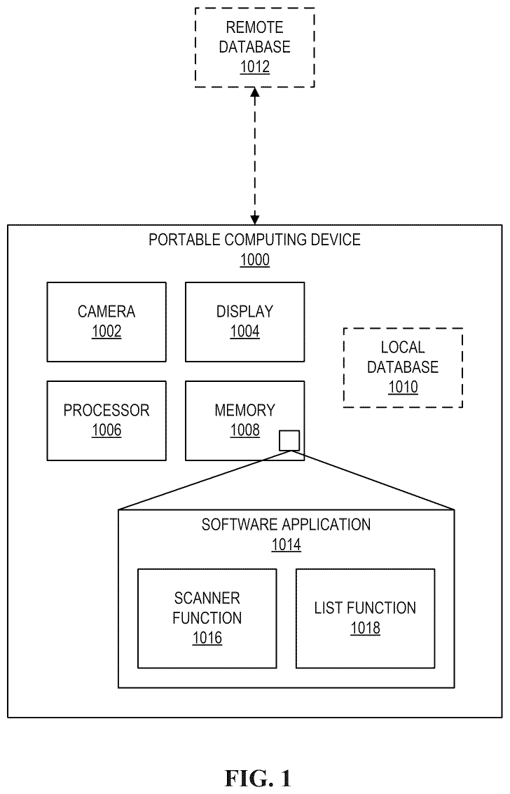

In this regard, FIG. 1 illustrates one example of a portable computing device 1000 in which embodiments of the present disclosure may be implemented. As illustrated, the portable computing device 1000 includes a camera 1002 (also referred to as an “integrated camera”), a display 1004 (e.g., a touchscreen display), a processor 1006 (e.g., a Central Processing Unit (CPU)), and memory 1008. Note that the portable computing device 1000 may include additional components that are not illustrated in FIG. 1 such as, for example, one or more wireless communication interfaces (e.g., a cellular network interface, a Wireless Local Area Network (WLAN) interface, etc.), a speaker(s), a microphone(s), an accelerometer(s), a gyroscope(s), facial recognition hardware, a battery, and/or the like. Optionally, the portable computing device 1000 includes a local database 1010 and/or is enabled to communicate with a remote database 1012, which may be hosted by a remote server. The local database 1010 and/or the remote database 1012 are used, in some embodiments, to store information that associates different computer-readable indicia (e.g., different barcodes or different QR codes to different items and/or different variations of an item(s)).

In accordance with embodiments of the present disclosure, a software application 1014 is stored in the memory 1008 and executed by the processor 1006. The software application 1014 includes a scanner function 1016 and a list function 1018. In operation, the software application 1014 utilizes the scanner function 1016 and the list function 1018 to provide a Graphical User Interface (GUI) on the display 1004 of the portable computing device 1000 that enables continuous scanning of computer-readable indicia associated to different items and/or different variations of an item(s) and adding of these items to a list (e.g., a shopping cart, an inventory list, or the like). The operation of the software application 1014 including the scanner function 1016 and the list function 1018 as well as the provided GUI are described below.

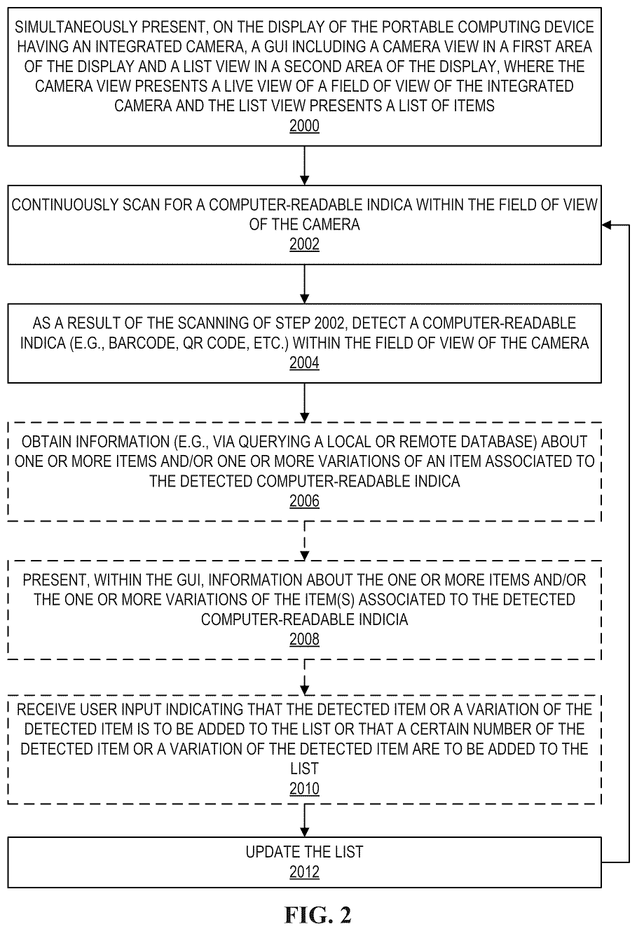

FIG. 2 is a flow chart that illustrates the operation of the software application 1014 at the portable computing device 1000, in accordance with embodiments of the present disclosure. Optional steps are represented by dashed boxes. Further, while the flow chart illustrates the steps as being performed in a particular order, these steps may be performed in any suitable order and some steps may be performed in parallel unless otherwise stated or required. As illustrated, the software application 1014 causes the portable computing device 1000 to simultaneously present, on the display 1004 of the portable computing device 1000, a GUI including: (a) a camera view in a first area of the display 1004 that presents a live view of a field of view of the camera 1002 of the portable computing device 1000 and (b) a list view in which the list function 1018 of the software application 1014 presents a list of items (e.g., a shopping cart, an inventory list, or the like) (step 2000).

The scanner function 1016 of the software application 1014 causes the portable computing device 1000 to continuously scan for a computer-readable indicia within the field of view of the camera 1002 (step 2002). As a result of the continuous scanning, the scanner function 1016 of the software application 1014 detects a particular computer-readable indicia within the field of view of the camera 1002 (step 2004). The detected computer-readable indicia is associated to a particular item (e.g., a physical item such as an article of clothing being sold, a medical supply, a library book, or the like), a particular variation of a particular item (e.g., a particular print of a certain dress, a particular size of an article of clothing, a particular dosage of a medication, or the like), or multiple variations of a particular item (e.g., all prints and/or all sizes of a particular article of clothing). The software application 1014 (e.g., the scanner function 1016) obtains information (e.g., text description and/or a thumbnail image) about the item or the variation(s) of the item associated to the detected computer-readable indicia, e.g., from the local database 1010 or the remote database 1012 (step 2006). In order to obtain user input that confirms that the item (or a variation of the item) associated to the detected computer-readable indicia is to be added to the list presented in the list view, user input may be obtained. More specifically, the software application 1014 (e.g., the scanner function 1016) presents, within the GUI (e.g., via an overlay pop-up area), at least some of the obtained information about the item or the variation(s) of the item associated to the detected computer-readable indicia (step 2008). The software application 1014 (e.g., the scanner function 1016) receives user input via the GUI that indiciates that the item (or a certain number of the item) associated to the detected computer-readable indicia or a particular variation of the item (or a certain number of this variation) associated to the detected computer-readable indicia is to be added to the list (step 2010). The software application 1014 (e.g., the list function 1018) then updates the list presented in the list view to include the item (or certain number of the item) associated to the detected computer-readable indicia or the (e.g., user selected) variation of the item (or a certain number of the variation of the item) associated to the detected computer-readable indicia (step 2012). The process may then return to step 2002 and repeat for continuous scanning and updating of the list.

Note that, in some scenarios, different items may be associated to the same computer-readable indicia, either on purpose or accidentally. In this case, the information obtained in step 2006 may include information about multiple items associated to the same detected computer-readable indicia, where user input is then received to select one of the multiple items to be added to the list.

Also note that a “time-out” feature may be used in some embodiments to clear out a scanned item (e.g., a scanned item that is not added to the list) even if a new item is not scanned. For example, upon detecting a computer-readable indicia and presenting information in the GUI about the associated item, a timer may be started. If the item is not added to the list within a predefined or configured amount of time (e.g., 5 seconds, 10 seconds, or the like), the information about the item may be removed from the GUI and the continuous scanning is resumed. As one example alternative, the continuous scanning may continue even when information is presented about an item associated to a detected computer-readable indicia, and, when a new computer-readable indicia is detected, any information about an item associated to a previously detected computer-readable indicia is replaced in the GUI with information about the item associated to the newly detected computer-readable indicia.

Using the process of FIG. 2, scanning of items is achieved in a manner that is efficient in terms of both processor resource consumption and number of user touches. In particular, by simultaneously presenting both the camera view used for scanning and the list view, the user does not need to repetitively switch between different full screen views for scanning and viewing the list of items and, in addition, the camera view does not need to be re-initialized and potentially manually re-configured each time that user switches back to the camera view, as is the case when using prior solutions,

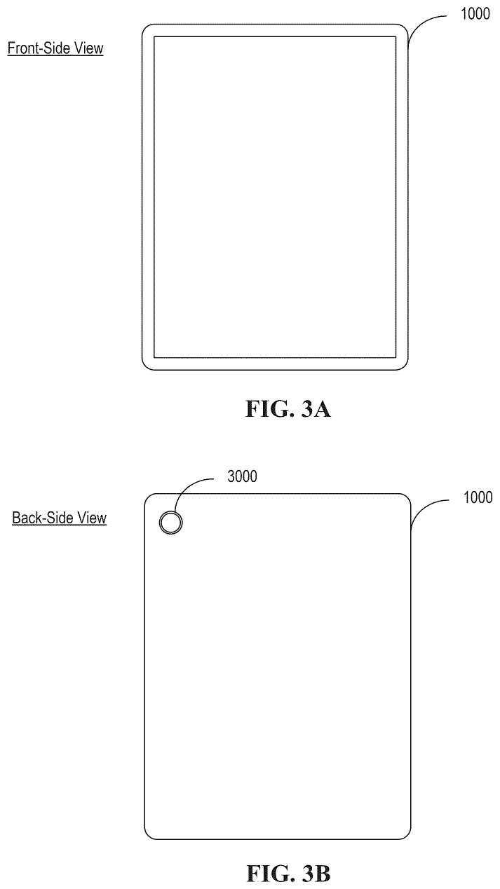

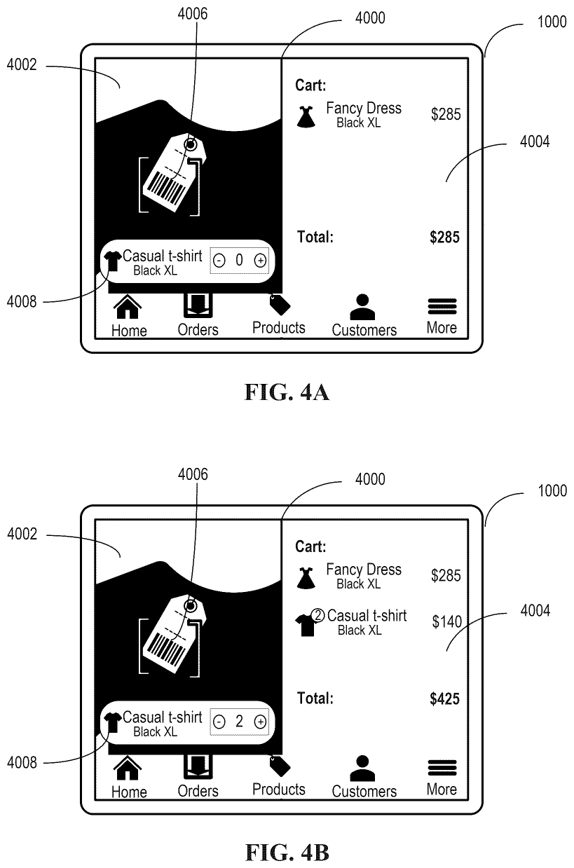

FIGS. 3A and 3B and FIGS. 4A and 4B illustrate one example embodiment of the portable computing device 1000 and one illustrative example of the GUI provided by the software application 1014 and the process of FIG. 2. In the example of FIGS. 3A and 3B, the portable computing device 1000 is a tablet computer. FIG. 3A illustrates the front-side (i.e., the display side) of the tablet computer, and FIG. 3B illustrates the back-side of the tablet computer. As illustrated in FIG. 3B, a lens 3000 of the camera 1002 is located on the back-side of the tablet computer, in which case the camera 1002 is also referred to as a rear-facing camera of the tablet computer.

FIG. 4A illustrates an example of the GUI provided on the display 1004 by the software application 1014. Here, the GUI is denoted as GUI 4000. Using the process of FIG. 2, the software application 1014 provides the GUI 4000 including a camera view 4002 presented in a first area of the display 1004 and a list view 4004 presented in a second area of the display 1004, where in this example the first and second areas of the display 1004 are non-overlapping (i.e., mutually exclusive areas of the display 1004). As a result of the continuous scanning within the field of view of the camera 1002, a computer-readable indicia 4006 is detected. In the illustrated example, the computer-readable indicia 4006 is a barcode on a price tag of a shirt. The software application 1014 obtains and presents information 4008 about the shirt associated to the detected computer-readable indicia 4006 within the GUI 4000. Then, as shown in the example of FIG. 4B, user input (e.g., screen touches) are received that indiciate that two (2) of the shirts associated to the detected computer-readable indicia 4006 are to be added to the list presented in the list view 4004, and the list is updated to include two (2) of the shirts.

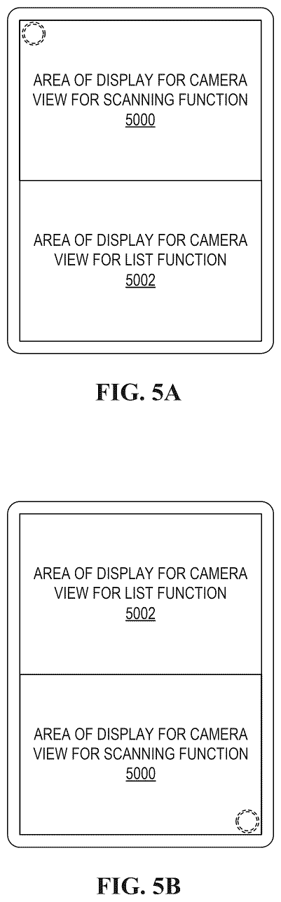

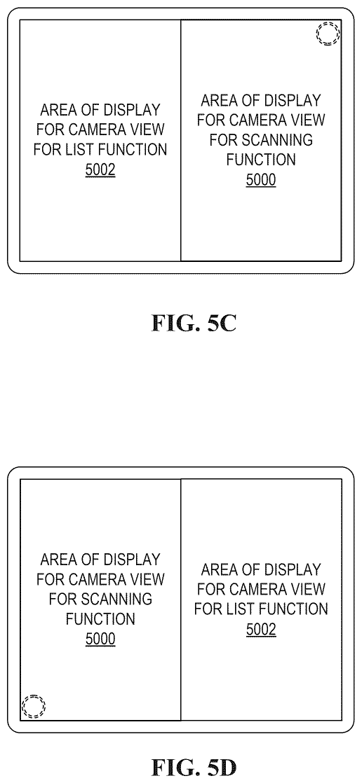

In addition to the simultaneous scanning in the camera view 4002 and updating of the list in the list view 4004, continuous scanning is enabled via an Augmented Reality (A/R) mechanism in which real-world, physical items are positioned (e.g., by the user) within the field of view of the rear-facing camera 1002 of the portable computing device 1000, and the software application 1014 presents the GUI 4000 in which the camera view 4002 shows the physical items within the field of view along with information about the physical items (by scanning the associated computer-readable indicia 4006 and obtaining the information about the associated item). The A/R mechanism is further enhanced by, in some embodiments, the software application 1014 intelligently controlling the GUI 4000 such that the area of the display 1004 in which the camera view 4002 is presented is a function of the position of the lens 3000 of the (rear-facing) camera 1002. In other words, the area of the display 1004 in which the camera view 4002 is presented on the front-side of the portable computing device 1000 is aligned with the lens 3000 of the camera 1002 on the back-side of the portable computing device 1000. Examples are shown in FIGS. 5A, 5B, 5C, and 5D. As shown in these figures, as the orientation of the portable computing device 1000 is changes, the position of area 5000 of the display 1004 in which the camera view is presented on the front-side of the portable computing device 1000 also changes to be aligned with the lens 3000 of the camera 1002 on the back-side of the portable computing device 1000. Area 5002 of the display 1004 in which the list view is presented on the front-side of the portable computing device 1000 also changes in a corresponding manner.

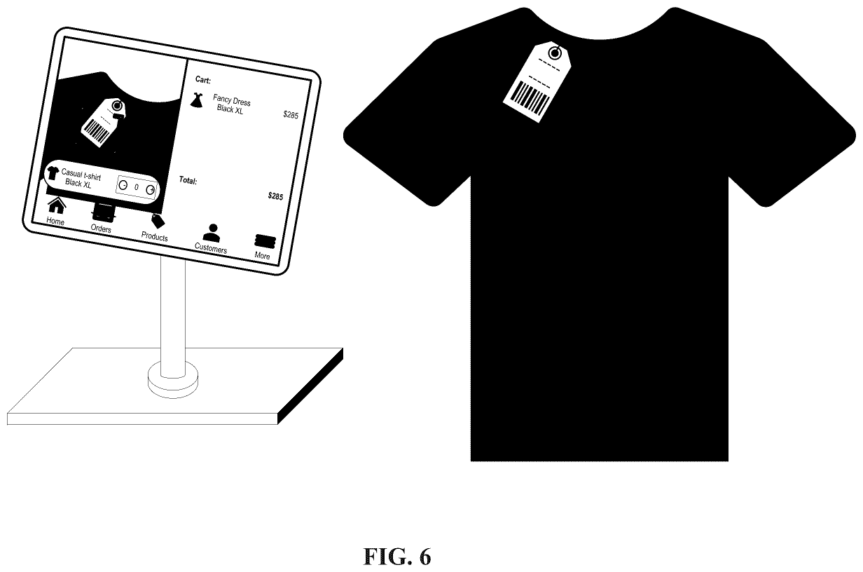

The A/R mechanism provides a “look-through” feature (i.e., the user is enabled to easily “look through” the camera view 4002 of the GUI 4000 to scan items), as illustrated in the example of FIG. 6. This enables the user, or operator, to easily scan computer-readable indicia affixed to physical items even though the rear-facing camera 1002, which typically has a much higher resolution than the front-facing camera, is being used and even if the portable computing device 1000 is fixed in a stand (e.g., a counter-top stand). Without this look-through feature, it would be difficult for the user to know where to position the items for scanning of the computer-readable indicia 4006. Further, the look-through feature enables the easy use of the rear-facing camera 1002, which provides the advantage of the higher resolution of the rear-facing camera 1002 which in turn provides improved scanning. Scanning could be performed via the front-facing camera 1002, but the lower resolution of the front-facing camera 1002 may provide decreased scanning performance and the physical items being scanned, particularly if relatively large compared to the portable scanning device 1000, would block the user's view of the display 1004 of the portable scanning device 1000.

Note that the rear-facing camera 1002 typically has much higher resolution than a front-facing camera 1002 of the portable computing device 1000, which in turn improves scanning and enables the user to have a clear view of display 1004 of the portable computing device 1000 for viewing of the information presented via the display 1004 and interaction with the GUI 4000.

While embodiments of the software application 1014 described herein for any scenario in which scanning of items to create a list of items is desired, in one example, the list of items is a shopping cart in a shopping or retail environment. For instance, the portable computing device 1000 is, in one example, a POS device in a store.

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart anfd block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method comprising:
simultaneously presenting, on a display of a portable computing device having an integrated camera, a Graphical User Interface (GUI) of a software application, the GUI including:
a camera view in a first area of the display of the portable computing device, the camera view presenting a live view of a field-of-view of the integrated camera; and
a list view in a second area of the display of the portable computing device, the list view presenting a list of items;
continuously scanning, by the portable computing device, for a computer-readable indicia viewable within the camera view;
as a result of continuously scanning for a computer readable indicia viewable within the camera view, detecting, by the portable computing device, a computer-readable indicia viewable within the camera view, the computer-readable indicia being associated to an item; and
updating the list of items presented within the list view to include human-readable indicia of the item associated to the detected computer-readable indicia.

2. The method of claim 1, wherein the first area is a function of a position of a lens of the integrated camera on a back-side of the portable computing device.

3. The method of claim 1, wherein the first area is a function of a position of a lens of the integrated camera on a back-side of the portable computing device such that the first area is at a position on the display of the portable computing device that is opposite the position of the lens of the integrated camera on the back-side of the portable computing device.

4. The method of claim 1, further comprising, responsive to detecting the computer-readable indicia viewable within the camera view:
querying a local database at the portable computing device or a remote database hosted by a server for any one or more items associated to the detected computer-readable indicia; and
receiving a response from the local or remote database, the response comprising information about the item associated to the detected computer-readable indicia.

5. The method of claim 1, wherein the detected computer-readable indicia is associated to two or more items, and the method further comprises, responsive to detecting the computer-readable indicia viewable within the camera view:
simultaneously with presenting the camera view and the list view, presenting, within the GUI on the display of the portable computing device, information about the two or more items that are associated to the detected computer-readable indicia; and
receiving user input that selects one of the two or more items associated to the detected computer-readable indicia;
wherein updating the list of items presented within the list view comprises updating the list of items presented within the list view to include human-readable indicia of the selected item associated to the detected computer-readable indicia.

6. The method of claim 5, wherein presenting the information about the two or more items associated to the detected computer-readable indicia comprises presenting the information about the two or more items associated to the detected computer-readable indicia within the camera view.

7. The method of claim 1, wherein the detected computer-readable indicia is associated to two or more variations of the item, and the method further comprises, responsive to detecting the computer-readable indicia viewable within the camera view:
simultaneously with presenting the camera view and the list view, presenting, within the GUI on the display of the portable computing device, information about the two or more variations of the item that are associated to the detected computer-readable indicia; and
receiving user input that selects one of the two or more variations of the item associated to the detected computer-readable indicia;
wherein updating the list of items presented within the list view comprises updating the list of items presented within the list view to include human-readable indicia of the selected variation of the item associated to the detected computer-readable indicia.

8. The method of claim 7, wherein presenting the information about the two or more variations of the item associated to the detected computer-readable indicia comprises presenting the information about the two or more variations of the item associated to the detected computer-readable indicia within the camera view.

9. The method of claim 1, further comprising, responsive to detecting the computer-readable indicia viewable within the camera view:
simultaneously with presenting the camera view and the list view, presenting, within the GUI on the display of the portable computing device, information about the item associated to the detected computer-readable indicia; and
receiving user input that confirms that the item is to be added to the list of items presented within the list view;
wherein updating the list of items presented within the list view comprises updating the list of items presented within the list view to include human-readable indicia of the item associated to the detected computer-readable indicia responsive to receiving user input that confirms that the item is to be added to the list of items presented within the list view.

10. The method of claim 1, further comprising, responsive to detecting the computer-readable indicia viewable within the camera view:
simultaneously with presenting the camera view and the list view, presenting, within the GUI on the display of the portable computing device, information about the item associated to the detected computer-readable indicia; and
receiving user input that confirms that a certain number of the item is to be added to the list of items presented within the list view;
wherein updating the list of items presented within the list view comprises updating the list of items presented within the list view to include human-readable indicia of the item associated to the detected computer-readable indicia and the certain number of the item, responsive to receiving user input that confirms that the certain number of the item is to be added to the list of items presented within the list view.

11. The method of claim 10, wherein presenting the information about the item associated to the detected computer-readable indicia comprises presenting the information about the item associated to the detected computer-readable indicia within the camera view.

12. The method of claim 1, wherein the integrated camera is a rear-facing camera of the portable computing device, and the portable computing device is affixed to a stand.

13. A portable computing device, comprising:
a camera;
a display;
a processor associated with the camera and the display; and
memory storing instructions executable by the processor, whereby the portable computing device is operable to:
simultaneously present, on the display of the portable computing device having an integrated camera, a Graphical User Interface (GUI) of a software application, the GUI including:
a camera view in a first area of the display of the portable computing device, the camera view presenting a live view of a field-of-view of the integrated camera; and
a list view in a second area of the display of the portable computing device, the list view presenting a list of items;
continuously scan, by the portable computing device, for a computer-readable indicia viewable within the camera view;
as a result of continuously scanning for a computer readable indicia viewable within the camera view, detect, by the portable computing device, a computer-readable indicia viewable within the camera view, the computer-readable indicia being associated to an item; and
update the list of items presented within the list view to include human-readable indicia of the item associated to the detected computer-readable indicia.

14. The portable computing device of claim 13, wherein the first area is a function of a position of a lens of the integrated camera on a back-side of the portable computing device.

15. The portable computing device of claim 13, wherein the first area is a function of a position of a lens of the integrated camera on a back-side of the portable computing device such that the first area is at a position on the display of the portable computing device that is opposite the position of the lens of the integrated camera on the back-side of the portable computing device.

16. The portable computing device of claim 13, wherein, via execution of the software instructions by the processor, the portable computing device is further operable to, responsive to detecting the computer-readable indicia viewable within the camera view:
query a local database at the portable computing device or a remote database hosted by a server for any one or more items associated to the detected computer-readable indicia; and
receive a response from the local or remote database, the response comprising information about the item associated to the detected computer-readable indicia.

17. The portable computing device of claim 13, wherein, via execution of the software instructions by the processor, the portable computing device is further operable to, responsive to detecting the computer-readable indicia viewable within the camera view:
simultaneously with presenting the camera view and the list view, present, within the GUI on the display of the portable computing device, information about the two or more items that are associated to the detected computer-readable indicia; and
receive user input that selects one of the two or more items associated to the detected computer-readable indicia;
wherein updating the list of items presented within the list view comprises updating the list of items presented within the list view to include human-readable indicia of the selected item associated to the detected computer-readable indicia.

18. The portable computing device of claim 17, wherein the information about the two or more items associated to the detected computer-readable indicia is presented within the camera view.

19. The portable computing device of claim 13, wherein the detected computer-readable indicia is associated to two or more variations of the item, and, via execution of the software instructions by the processor, the portable computing device is further operable to, responsive to detecting the computer-readable indicia viewable within the camera view:
simultaneously with presenting the camera view and the list view, present, within the GUI on the display of the portable computing device, information about the two or more variations of the item that are associated to the detected computer-readable indicia; and
receive user input that selects one of the two or more variations of the item associated to the detected computer-readable indicia;
wherein updating the list of items presented within the list view comprises updating the list of items presented within the list view to include human-readable indicia of the selected variation of the item associated to the detected computer-readable indicia.

20. A non-transitory computer-readable medium storing instructions executable by a processor of a portable computing device, whereby the portable computing device is caused to:
simultaneously present, on a display of the portable computing device having an integrated camera, a Graphical User Interface (GUI) of a software application, the GUI including:
a camera view in a first area of the display of the portable computing device, the camera view presenting a live view of a field-of-view of the integrated camera; and
a list view in a second area of the display of the portable computing device, the list view presenting a list of items;
continuously scan, by the portable computing device, for a computer-readable indicia viewable within the camera view;
as a result of continuously scanning for a computer readable indicia viewable within the camera view, detect, by the portable computing device, a computer-readable indicia viewable within the camera view, the computer-readable indicia being associated to an item; and
update the list of items presented within the list view to include human-readable indicia of the item associated to the detected computer-readable indicia.
